(19) United States
(12) Patent Application Publication
(10) Pub. No.: US 2022/0172219 A1
(43) Pub. Date: Jun. 2, 2022

(54) PROVIDING CUSTOMER CARE BASED ON ANALYSIS OF CUSTOMER CARE CONTACT BEHAVIOR

(71) Applicant: AT&T Intellectual Property I, L.P., Atlanta, GA (US)

(72) Inventors: Wen-Ling Hsu, Bridgewater, NJ (US); Guang-Qin Ma, Kendall Park, NJ (US); Guy Jacobson, Bridgewater, NJ (US); Jenq-Chyuan Wang, East Hanover, NJ (US); Tan Xu, Bridgewater, NJ (US); Kevin McDorman, Dallas, TX (US); Brian Economaki, Richardson, TX (US); Shuai Zhao, Bellevue, WA (US)

(21) Appl. No.: 17/106,934

(22) Filed: Nov. 30, 2020

(51) Int. Cl. G06Q 30/00; G06Q 30/02; G06Q 10/10; G06F 16/28; G06N 3/08; G06N 3/04

(52) U.S. Cl. CPC G06Q 30/016; G06Q 30/0204; G06Q 30/0201; G06N 3/0445; G06F 16/285; G06N 3/08; G06Q 10/107

(57) ABSTRACT

A method, computer-readable medium, and apparatus for providing customer care for customers are disclosed. Customer care may be provided for customers by obtaining customer care contact information for a plurality of customers where the customer care contact information includes, for each of a plurality of customers, respective customer care contact data that is based on a sequence of customer care contacts by the customer with one or more customer care agents, determining customer care contact embedding information for the plurality of customers, clustering the customer care contact embedding information for the plurality of customers to form customer care contact clusters, determining customer care contact cluster characterization information for the customer care contact clusters, selecting, from the plurality of customers based on the customer care contact cluster characterization information for the customer care contact clusters, a set of customers, and initiating a customer care action for the set of customers.

The present disclosure relates generally to communication systems and, more particularly but not exclusively, to methods, computer-readable media, and apparatuses for providing customer care based on analysis of customer care contact behavior.

### SUMMARY

In one example, the present disclosure describes a method, computer-readable medium, and apparatus for providing customer care. In one example, customer care is provided based on analysis of customer care contact behavior by customers based on customer care contacts between customers and customer care agents.

In one example, a processing system including at least one processor may obtain customer care contact information comprising, for each of a plurality of customers, respective customer care contact data that is based on a sequence of customer care contacts by the customer with one or more customer care agents, determine customer care contact embedding information comprising, for each of the plurality of customers, a respective customer care contact embedding representing the respective customer care contact data, cluster the customer care contact embedding information to form a plurality of customer care contact clusters, determine, based on the customer care contact embedding information and the customer care contact information, customer care contact cluster characterization information comprising, for each of the customer care contact clusters, respective characterization information configured to characterize the customer care contact cluster based on the respective group of the customer care contact embeddings of the customer care contact cluster, select, from the plurality of customers based on the customer care contact cluster characterization information, a set of customers, and initiate a customer care action for the set of customers.

In one example, a processing system including at least one processor may obtain customer care contact information comprising, for each of a plurality of customers, respective customer care contact data based on a sequence of customer care contacts of the customer with one or more customer care agents, wherein the respective customer care contact data comprises an indication of one or more customer care contact channel types, from a set of customer care contact channel types, used for the sequence of customer care contacts of the customer, determining customer care contact embedding information comprising, for each of the plurality of customers, a respective customer care contact embedding representing the respective customer care contact data, clustering the customer care contact embedding information to form a plurality of customer care contact clusters, determining, based on the customer care contact embedding information and the customer care contact information, customer care contact cluster characterization information comprising, for each of the customer care contact clusters, respective characterization information characterizing the customer care contact cluster, wherein the customer care contact cluster characterization information is based on the set of customer care contact channel types, selecting, from the plurality of customers based on the customer care contact cluster characterization information, a set of customers, and initiating, for the set of customers, a customer care action configured to cause the set of customers to use a selected customer care contact channel type from the set of customer care contact channel types.

### BRIEF DESCRIPTION OF THE DRAWINGS

The teachings of the present disclosure can be readily understood by considering the following detailed description in conjunction with the accompanying drawings, in which:

FIG. 1 illustrates an example system including a customer management system configured to provide customer care based on customer care contact behavior of customers, according to the present disclosure;

FIG. 2 illustrates an example process for initiating a customer care action for customers based on customer care contact behavior of customers, according to the present disclosure;

FIG. 3 illustrates an example method for initiating a customer care action for customers based on customer care contact behavior of customers, according to the present disclosure; and

FIG. 4 illustrates a high-level block diagram of a computing device specially configured to perform the functions, methods, operations, and algorithms described herein.

To facilitate understanding, identical reference numerals have been used, where possible, to designate identical elements that are common to the figures.

### DETAILED DESCRIPTION

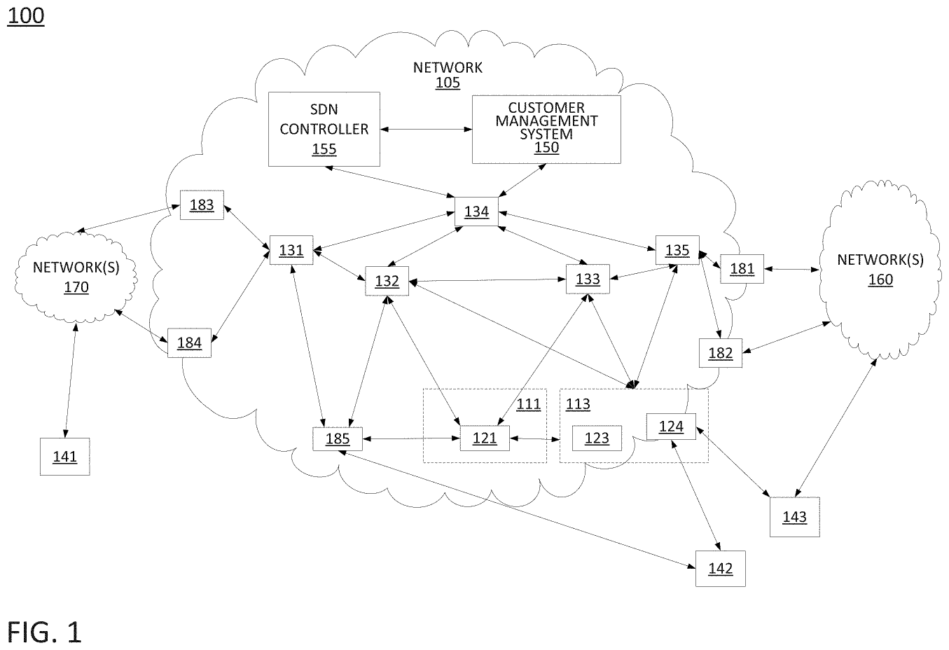

The present disclosure broadly discloses methods, computer-readable media, and apparatuses for providing customer care for customers. Customer care may be provided for customers based on analysis of the customer care contact behavior of the customers (e.g., the number of customer care contacts by the customers with customer care agents, customer care contact channel types used by the customers for customer care contacts with customer care agents, reasons for customer care contacts by the customers with customer care agents, and so forth). Customer care may be provided for customers, based on analysis of customer care contact behavior of the customers, by using the analysis of customer care contact behavior of the customers to identify a set of customers and initiating a customer care contact action for the set of customers (e.g., for controlling or influencing the number of customer care contacts by the customers, the customer care contact channel types used by the customers for the customer care contacts, and so forth). In one example, a processing system including at least one processor may obtain customer care contact information comprising, for each of a plurality of customers, respective customer care contact data that is based on a sequence of customer care contacts by the customer with one or more customer care agents, determine customer care contact embedding information comprising, for each of the plurality of customers, a respective customer care contact embedding representing the respective customer care contact data, cluster the customer care contact embedding information to form a plurality of customer care contact clusters, determine, based on the customer care contact embedding information and the customer care contact information, customer care contact cluster characterization information comprising, for each of the customer care contact clusters, respective characterization information configured to characterize the customer care contact cluster based on the respective group of the customer care contact embeddings of the customer care contact cluster, select, from the plurality of customers based on the customer care contact cluster characterization information, a set of customers, and initiate a customer care action for the set of customers. It is noted that these and other aspects of the present disclosure are described in greater detail below in connection with the discussion of FIGS. 1-4.

To better understand the present disclosure, FIG. 1 illustrates a block diagram depicting one example of a communication network or system 100 for performing or enabling the steps, functions, operations, and/or features described herein. The system 100 may include any number of interconnected networks which may use the same or different communication technologies. As illustrated in FIG. 1, system 100 may include a network 105, e.g., a core telecommunication network.

In one example, the network 105 may include a backbone network, or transport network, such as an Internet Protocol (IP)/multi-protocol label switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may alternatively or additionally include components of a cellular core network, such as a Public Land Mobile Network (PLMN), a General Packet Radio Service (GPRS) core network, and/or an evolved packet core (EPC) network, an Internet Protocol Multimedia Subsystem (IMS) network, a Voice over Internet Protocol (VoIP) network, and so forth. In one example, the network 105 uses a network function virtualization infrastructure (NFVI), e.g., servers in a data center or data centers that are available as host devices to host virtual machines (VMs) including virtual network functions (VNFs). In other words, at least a portion of the network 105 may incorporate software-defined network (SDN) components. In this regard, it is noted that, as referred to herein, “traffic” may include all or a portion of a transmission, e.g., a sequence or flow, including one or more packets, segments, datagrams, frames, cells, PDUs, service data unit, bursts, and so forth. The particular terminology or types of data units involved may vary depending upon the underlying network technology. Thus, the term “traffic” is intended to refer to any quantity of data to be sent from a source to a destination via one or more networks.

In one example, the network 105 may be in communication with networks 160 and networks 170. Networks 160 and 170 may each include a wireless network (e.g., an Institute of Electrical and Electronics Engineers (IEEE) 802.11/Wi-Fi network and the like), a cellular access network (e.g., a Universal Terrestrial Radio Access Network (UTRAN) or an evolved UTRAN (eUTRAN), and the like), a circuit switched network (e.g., a public switched telephone network (PSTN)), a cable network, a digital subscriber line (DSL) network, a metropolitan area network (MAN), an Internet service provider (ISP) network, a peer network, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may include separate domains, e.g., separate routing domains from the network 105. In one example, networks 160 and/or networks 170 may represent the Internet in general.

In one example, network 105 may transport traffic to and from user devices 141-143. For instance, the traffic may relate to communications such as voice telephone calls, video and other multimedia, text messaging, emails, and so forth among the user devices 141-143, or between the user devices 141-143 and other devices that may be accessible via networks 160 and 170. For instance, the traffic may relate to management actions performed on the network 105 (e.g., management actions such as create/update/delete (CRUD) operations, queries, and so forth). User devices 141-143 may include, for example, cellular telephones, smart phones, personal computers, other wireless and wired computing devices, private branch exchanges, customer edge (CE) routers, media terminal adapters, cable boxes, home gateways and/or routers, and so forth.

In one example, user devices 141-143 may communicate with or may communicate via network 105 in various ways. For example, user device 141 may include a cellular telephone which may connect to network 105 via network 170, e.g., a cellular access network. For instance, network 170 may include one or more cell sites, e.g., including a base transceiver station (BTS), a NodeB, an evolved NodeB (eNodeB), or the like (broadly, a “base station”), a remote radio head (RRH) and baseband unit, a base station controller (BSC) or radio network controller (RNC), and so forth. In such an example, components 183 and 184 in network 105 may include a serving gateway (SGW), a mobility management entity (MME), or the like. In one example, user device 142 may include a customer edge (CE) router which may provide access to network 105 for additional user devices (not shown) which may be connected to the CE router. For instance, in such an example, component 185 may include a provider edge (PE) router.

In one example, the network 105 may include virtual network functions (VNFs) which may physically include hardware executing computer-readable/computer-executable instructions, code, and/or programs to perform various functions. As illustrated in FIG. 1, units 123 and 124 may reside on a network function virtualization infrastructure (NFVI) 113, which is configurable to perform a broad variety of network functions and services. For example, NFVI 113 may include shared hardware, e.g., one or more host devices including line cards, central processing units (CPUs), or processors, memories to hold computer-readable/computer-executable instructions, code, and/or programs, and so forth. For instance, in one example unit 123 may be configured to be a firewall, a media server, a Simple Network Management protocol (SNMP) trap, etc., and unit 124 may be configured to be a PE router, e.g., a virtual PE (VPE) router, which may provide connectivity to network 105 for user devices 142 and 143. In one example, NFVI 113 may represent a single computing device and units 123 and 124 may physically reside on the same host device. In another example, NFVI 113 may represent multiple host devices such that units 123 and 124 may reside on different host devices. In one example, unit 123 and/or unit 124 may have functions that are distributed over a plurality of host devices. For instance, unit 123 and/or unit 124 may be instantiated and arranged (e.g., configured/programmed via computer-readable/computer-executable instructions, code, and/or programs) to provide for load balancing between two processors and several line cards that may reside on separate host devices.

In one example, the network 105 may also include an additional NFVI 111. For instance, unit 121 may be hosted on NFVI 111, which may include host devices having the same or similar physical components as NFVI 113. In addition, NFVI 111 may reside in a same location or in different locations from NFVI 113. As illustrated in FIG. 1, unit 121 may be configured to perform functions of an internal component of network 105. For instance, due to the connections available to NFVI 111, unit 121 may not function as a PE router, a SGW, a MME, a firewall, etc. Instead, unit 121 may be configured to provide functions of components that do not utilize direct connections to components external to network 105, such as a call control element (CCE), a media server (MS), a domain name service (DNS) server, a packet data network gateway (PGW), a gateway mobile switching center (GMSC), a short message service center (SMSC), etc.

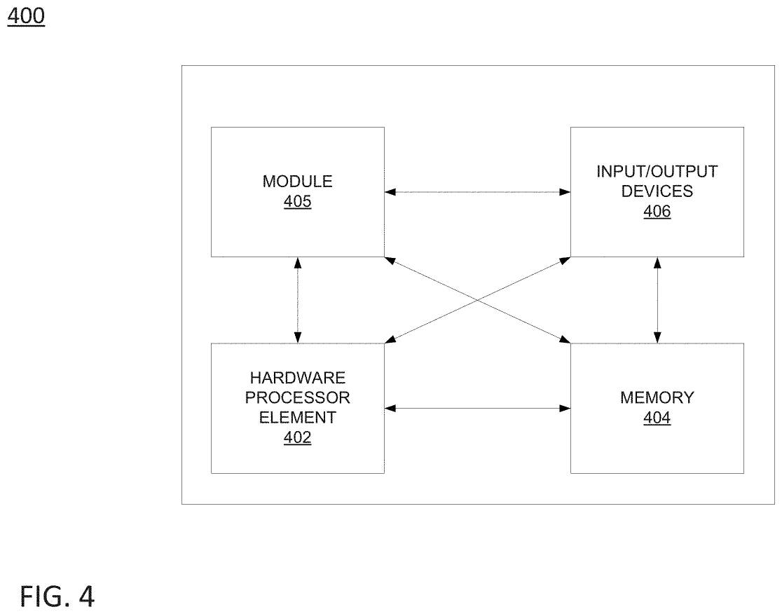

In one example, the network 105 includes a software defined network (SDN) controller 155. In one example, the SDN controller 155 may comprise a computing device or processing system (e.g., a server), such as computing system 400 depicted in FIG. 4, and may be configured to provide one or more operations or functions in connection with examples of the present disclosure for providing customer care for customers.

In one example, NFVI 111 and unit 121, and NFVI 113 and units 123 and 124 may be controlled and managed by the SDN controller 155. For instance, in one example, SDN controller 155 is responsible for such functions as provisioning and releasing instantiations of VNFs to perform the functions of routers, switches, and other devices, provisioning routing tables and other operating parameters for the VNFs, and so forth. In one example, SDN controller 155 may maintain communications with VNFs and/or host devices/NFVI via a number of control links which may include secure tunnels for signaling communications over an underling IP infrastructure of network 105. In other words, the control links may include virtual links multiplexed with transmission traffic and other data traversing network 105 and carried over a shared set of physical links. For ease of illustration the control links are omitted from FIG. 1. In one example, the SDN controller 155 also may include a virtual machine operating on NFVI/host device(s), or may include a dedicated device. For instance, SDN controller 155 may be collocated with one or more VNFs, or may be deployed in a different host device or at a different physical location.

In one example, the functions of SDN controller 155 may include the selection of NFVI from among various NFVI available in network 105 (e.g., NFVI 111 or 113) to host various devices, such as routers, gateways, switches, etc., and the instantiation of such devices. For example, with respect to units 123 and 124, SDN controller 155 may download computer-executable/computer-readable instructions, code, and/or programs (broadly “configuration code”) for units 123 and 124 respectively, which when executed by a processor of the NFVI 113, may cause the NFVI 113 to perform as a PE router, a gateway, a route reflector, a SGW, a MME, a firewall, a media server, a DNS server, a PGW, a GMSC, a SMSC, a CCE, and so forth. In one example, SDN controller 155 may download the configuration code to the NFVI 113. In another example, SDN controller 155 may instruct the NFVI 113 to load the configuration code previously stored on NFVI 113 and/or to retrieve the configuration code from another device in network 105 that may store the configuration code for one or more VNFs. The functions of SDN controller 155 may also include releasing or decommissioning unit 123 and/or unit 124 when no longer required, the transferring of the functions of units 123 and/or 124 to different NFVI, e.g., when NVFI 113 is taken offline, and so on.

In one example, SDN controller 155 may represent a processing system including a plurality of controllers, e.g., a multi-layer SDN controller, one or more federated layer 0/physical layer SDN controllers, and so forth. For instance, a multi-layer SDN controller may be responsible for instantiating, tearing down, configuring, reconfiguring, and/or managing layer 2 and/or layer 3 VNFs (e.g., a network switch, a layer 3 switch and/or a router, etc.), whereas one or more layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, and so forth. In one example, the layer 0 SDN controller(s) may in turn be controlled by the multi-layer SDN controller. For instance, each layer 0 SDN controller may be assigned to nodes/optical components within a portion of the network 105. In addition, various components may be co-located or distributed among a plurality of different dedicated computing devices or shared computing devices (e.g., NFVI) as described herein.

In one example, the network 105 may also include internal nodes 131-135, which may include various components, such as routers, switches, route reflectors, etc., cellular core network, IMS network, and/or VoIP network components, and so forth. In one example, these internal nodes 131-135 may also include VNFs hosted by and operating on additional NFVIs. For instance, as illustrated in FIG. 1, internal nodes 131 and 135 may include VNFs residing on additional NFVI (not shown) that are controlled by SDN controller 155 via additional control links. However, at least a portion of the internal nodes 131-135 may include dedicated devices/components, e.g., non-SDN reconfigurable devices.

In one example, the network 105 may also include components 181 and 182, e.g., PE routers interfacing with networks 160, and component 185, e.g., a PE router which may interface with user device 142. For instance, in one example, network 105 may be configured such that user device 142 (e.g., a CE router) is dual-homed. In other words, user device 142 may access network 105 via either or both of unit 124 and component 185. As mentioned above, components 183 and 184 may include an SGW, an MME, or the like. However, in another example, components 183 and 184 also may include PE routers interfacing with network(s) 170, e.g., for non-cellular network-based communications. In one example, components 181-185 also may include VNFs hosted by and operating on additional NFVI. However, in another example, at least a portion of the components 181-185 may include dedicated devices or components.

In one example, the network 105 may include a customer management system 150. The customer management system 150 is configured to support various customer management functions for customers of the network provider of the network 105. In one example, the customer management system 150 may comprise a computing device or processing system (e.g., a server or other suitable systems), such as computing system 400 depicted in FIG. 4, and may be configured to provide one or more operations or functions in connection with examples of the present disclosure for providing customer care for customers.

The customer management system 150 may be configured to support various customer care functions which may be provided by customer care agents of the network provider of the network 105 for customers of the network provider of the network 105. The customers may include various customers of the network provider, such as home consumers (e.g., families with mobile devices for each member of the family), business consumers (e.g., small businesses with devices for employees), enterprise customers, and so forth. The customer care agents may include human customer care agents and/or automated customer care agents (e.g., chatbots or other automated customer care agents). The customer care functions may be based on customer care contacts, or customer care interactions, between the customers and the customer care agents. The customer care provided to customers of the network provider by the customer care agents may be provided via a number of customer care contact channel types available for customer care contact by customer care agents with customers (e.g., visits to stores for in-person customer care interaction, telephone calls for voice-based customer care interaction, chat-based communication interfaces for chat-based customer care interaction, and so forth). The customer care provided to customers of the network provider may be provided via an automated customer care contact channel type in which customer care may be provided for customers without interaction with customer care agents (e.g., directing customers to websites, informational or instructional videos, automated tools, and so forth). It will be appreciated that various other customer care contact channel types may be used.

The customer management system 150 may be configured to enable customers of the network provider and customer care agents of the network provider to perform customer management functions. It will be appreciated, as discussed further below, that at least some such functions will be based on various types of interactions between customers and customer care agents via various types of customer care contact channels.

The customer management system 150 may be configured to support contacts with customers for enabling the customers to perform customer management functions. For example, the customer management system 150 may provide various interfaces to customers for enabling customers to review account information, modify account information, view and pay bills, open trouble tickets related to device and/or service problems, and so forth. These interfaces may be independent of certain customer care contact channel types (e.g., where customers do not rely on interactions with customer care agents to perform such functions, such as where an automated customer care contact channel type is used) or may be associated with certain customer care contact channel types (e.g., where customers may rely on interactions with customer care agents to perform such functions, such as entering to a store and asking a customer care agent in the store for information, calling a customer care telephone number and speaking with a customer care agent over the phone to report a problem with service, and so forth). It will be appreciated that the customer management system 150 may be configured to support various other capabilities for enabling customers to perform customer management functions.

The customer management system 150 may be configured to support contacts with customer care agents for enabling the customer care agents to perform customer management functions. For example, the customer management system 150 may provide various interfaces to customer care agents for enabling the customer care agents to communicate with customers, access customer account information, perform device and/or service troubleshooting functions, and so forth. These interfaces may be independent of certain customer care contact channel types (e.g., where customer care agents do not rely on interactions with customers to perform such functions and instead perform such functions for customers independent of interactions with the customers) or may be associated with the various customer care contact channel types (e.g., where customer care agents may rely on interactions with customers to perform such functions, such as where a customer enters a store and asks the customer care agent for information, a customer calls a customer care telephone number and speaks with a customer care agent over the phone to report a problem with service, and so forth). It will be appreciated that the customer management system 150 may be configured to support various other capabilities for enabling customer care agents to perform customer management functions.

The customer management system 150, as indicated above, may support contacts between customers and customer care agents through a number of different customer care contact channel types (e.g., store, phone, chat, automated, and so forth). Different customers may prefer different customer care contact channel types (e.g., some customers may prefer to go to the store and speak with a customer care agent in person, some customers may prefer to speak with a customer care agent over the phone, some customers may prefer not to speak with a customer care agent in person or on the phone and instead to chat with a customer care agent via text-based chat interfaces, some customers may prefer to use automated capabilities and tools that do not require interaction with customer care agents in order to handle various customer care needs, and so forth). Many customers may use different customer care contact channel types under different conditions (e.g., at different times (e.g., stopping at a store when the customer is out, calling for support when the customer is unable to go out or does not want to go out, etc.), for different contact reasons (e.g., stopping into a store when there is a device problem, using a chat interface for billing inquiries, using a tool to troubleshoot a potential problem, etc.), and so forth). Accordingly, it will be appreciated that, as customers engage in customer care contacts with the network provider over time, this results in sets, or sequences, of customer care contacts for the customers.

The customer management system 150 may maintain various types of customer-related information. The customer-related information may include information generated based on customer management functions, such as customer account information (e.g., name, address, number of lines, supported services, and so forth) generated during customer onboarding, customer care contact information (e.g., customer care contact records including customer care contact data for customer care contacts between customers of the network provider and customer care agents of the network provider, which may include a customer care contact date and time, an indication of the customer care contact channel type used for the customer care contact, notes generated by a customer care agent during the customer care contact which may include reasons for the customer care contacts, and so forth) generated during customer care contacts between customers and customer care agents via various customer care contact channel types, and so forth. The customer-related information may be used to support customer care contacts between customers and customer care agents via various customer care contact channels of various customer care contact channel types, which also may result in generation of additional customer care contact information based on customer care contacts between customers and customer care agents via various customer care contact channels of various customer care contact channel types. The customer care contact data for a customer may include, based on a sequence of customer care contacts by the customer with customer care agents, a quantity of the customer care contacts by the customer, customer care contact channel information for the customer care contacts by the customers (e.g., an indication of the customer care contact channel types used, a customer care contact sequence indicative of the sequence of customer care contact channel types used, and so forth), gap time information related to gaps between the customer care contacts by the customer (e.g., gap times between adjacent customer care contacts, which may be measured in hours, days, weeks, or the like), customer care contact reason information indicative of the reasons for the customer care contacts by customers (e.g., reason codes, freeform reason descriptions entered by customer care agents, or the like), and so forth. The customer-related information may include customer profile data for customers, customer event data for customers, and so forth. The customer-related information may include various other types of data which may be associated with customers.

The customer management system, as indicated above, may maintain customer care contact data for a sequence of customer care contacts by the customer with customer care agents using various combinations of customer care contact channel types. For example, a customer care contact sequence for a customer may be “sssss,” meaning that the customer has had five customer care contacts and that all five of the customer care contacts were in store (s). For example, a customer care contact sequence for a customer may be “sscccc,” meaning that the first two customer care contacts were in store and the four most recent customer care contacts were via calls (c). For example, a customer care contact sequence for a customer may be “cctttttc,” which means that the first two customer care contacts were calls, the next five customer care contacts were chat-based contacts (t), and the last customer care contact was another call. It will be appreciated that various aspects of customer care contact data for sequences of customer care contacts of customers (e.g., the number of customer care contacts the customer has had with the network provider, the customer care contact channel types used during the customer care contacts, the gaps between customer care contacts, the reasons for the customer care contacts, and so forth) may vary across different customers.

The customer management system 150 may be configured to analyze customer-related information to support customer care for customers (e.g., to enable the network provider to provide improved customer care for customers, to reduce the costs incurred by the network provider in providing customer care for customers, and so forth). The customer management system 150 may be configured to analyze customer care contact information to support customer care for customers. The customer management system 150 may be configured to combine analysis of customer care contact information and other customer-related information (e.g., customer account information, customer profile information, customer event information, and so forth) to support customer care for customers. The customer management system 150 may be configured to use various other types of customer-related information to support customer care for customers.

The customer management system 150 may be configured to support customer care for customers, based on analysis of customer care contact behavior of the customers, by obtaining customer care contact information comprising, for each of a plurality of customers, respective customer care contact data that is based on a sequence of customer care contacts by the customer with one or more customer care agents, determining customer care contact embedding information comprising, for each of the plurality of customers, a respective customer care contact embedding representing the respective customer care contact data, clustering the customer care contact embedding information to form a plurality of customer care contact clusters, determining, based on the customer care contact embedding information and the customer care contact information, customer care contact cluster characterization information comprising, for each of the customer care contact clusters, respective characterization information configured to characterize the customer care contact cluster based on the respective group of the customer care contact embeddings of the customer care contact cluster, selecting, from the plurality of customers based on the customer care contact cluster characterization information, a set of customers, and initiating a customer care action for the set of customers. The customer care action for the set of customers may be configured to control, or at least attempt to control, the behavior of customers (e.g., number of contacts by the customers, the customer care contact channel types used by the customers, and so forth), which may result in improved customer care for the customers, reduced costs to the network provider to provide customer care to the customers, and so forth.

The customer management system 150, as indicated above, may be configured to obtain customer care contact information that includes, for each customer, respective customer care contact data that is based on a sequence of customer care contacts by the customer with one or more customer care agents. The customer care contact information may include raw customer care contact data for each customer (e.g., for each customer, data including fields such as a total number of customer care contacts, a customer care contact string indicative of the customer care contact channel types used in the sequence of customer care contacts, gap time information for gaps between customer care contacts in the sequence of customer care contacts, reason information including reasons for each of the customer care contacts in the sequence of customer care contacts, and so forth). The customer care contact information may include processed customer care contact data for each customer (e.g., for each customer, a sequence of customer care contact data for a sequence of customer care contacts of the customer, which may be organized as a sequence of data structures corresponding to the sequence of customer care contacts of the customer). The customer care contact information may be represented in other suitable formats.

The customer management system 150, as indicated above, may be configured to determine customer care contact embedding information that includes, for each of the customers, a respective customer care contact embedding representing the respective customer care contact data. The customer care contact embedding for a customer may be determined based on conversion of a first sequence including the customer care contact data and having a first dimensionality to a second sequence including the customer care contact embedding and having a second dimensionality that is lower than the first dimensionality. The customer care contact embeddings of the customers may be sequence-to-sequence (Seq2Seq) embeddings of the customer care contact data for the customers, which may be learned using a Seq2Seq generative learning model or method (although it will be appreciated that other types of embeddings may be determined based on other types of learning models or methods). It will be appreciated that various other models and algorithms may be applied for determining the customer care contact embeddings of the customer care contact data for the customers.

The customer management system 150, as indicated above, may be configured to determine the customer care contact embeddings based on the customer care contact data as Seq2Seq embeddings. For a given customer, the customer care contact data for the customer may include sequences of values for each of the customer care contacts of the customers, which may be used to indicate the customer care contact channel types of the respective customer care contacts, gaps between the customer care contacts, and customer care contact reasons identified during the customer care contacts. For example, the sequences of values for the customer care contact data may be provided using a data structure such as [c¹, c², c³, gd, r¹, r², . . . , r^{m}], where c¹, c², and c³ are bit positions corresponding to three different possible customer care contact channel types (e.g., store (s), call (c), and chat (t)) such that setting one of the three bits indicates the customer care contact channel type used for the customer care contact, gd may be used to indicate the gap time between adjacent customer care contacts, and r¹ through r^{m} are bit positions corresponding to the set of all possible customer care contact reasons such that setting one or more of the bits indicates the one or more reasons for the customer care contact. For a given customer, the customer care contact embedding may include a sequence of values configured to provide a lower-dimensionality representation of the customer care contact data. For example, the sequence of values for the customer care contact embeddings may be provided using a data structure such as [e¹, e², . . . , e^{d}], where d represents the dimensionality of the customer care contact embedding which is expected to be significantly less than the dimensionality of the customer care contact data that is used to determine the customer care contact embedding.

The customer management system 150, as indicated above, may be configured to cluster the customer care contact embedding information to form a plurality of customer care contact clusters. The customer care contact clusters may include respective groups of the customer care contact embeddings and, thus, also may be referred to as customer care contact embedding clusters. The clustering of the customer care contact embedding information, which includes clustering of the customer care contact embeddings for the customers, to form the customer care contact clusters may be performed based on a clustering model. The clustering model that is used for clustering the customer care contact embeddings may be a centroid-based clustering model (e.g., a K-means clustering model or other suitable types of centroid-based clustering model) or other suitable types of clustering model. It will be appreciated that, where a centroid-based clustering model is used, the centroids of the customer care contact clusters may be used as a basis for matching customers to customer care contact clusters (e.g., based on comparisons of the customer care contact embeddings of the customers with the centroids of the customer care contact clusters). It will be appreciated that various other models and algorithms may be applied for clustering the embeddings of the customer care contact data of the customers into clusters.

The customer management system 150, as indicated above, may be configured to determine, based on the customer care contact embedding information and the customer care contact information, customer care contact cluster characterization information comprising, for each of the customer care contact clusters, respective characterization information configured to characterize the customer care contact cluster based on the respective group of the customer care contact embeddings of the customer care contact cluster. The customer care contact cluster characterization information for the customer care contact clusters may be determined based on mappings between the customer care contact embeddings of the customers and the customer care contact data of the customers. The customer care contact cluster characterization information for the customer care contact clusters may be determined by associating the customers with the customer care contact clusters based on the customer care contact embeddings of the customers and then, for each of the customer care contact clusters, use the customer care contact data for the customers associated with the respective customer care contact cluster to determine the customer care contact cluster characterization information for the respective customer care contact cluster. The customers may be associated with the customer care contact clusters, based on the customer care contact embeddings of the customers, by, for each of the customers, comparing the customer care contact embedding of the respective customer with each of the customer care contact clusters (e.g., comparisons of the customer care contact embedding of the respective customer with the centroids of the customer care contact clusters) to find the customer care contact cluster most closely matched for the respective customer (e.g., closest centroid) and then associating the respective customer with the customer care contact cluster most closely matched for the respective customer. The customer care contact data for the customers associated with the respective customer care contact clusters may be used to determine the customer care contact cluster characterization information for the customer care contact clusters by, for each of the customer care contact clusters, analyzing the customer care contact data for the set of customers determined to be associated with the respective customer care contact cluster in order to determine customer care contact data common to the set of customers determined to be associated with the respective customer care contact cluster, which may then be used to characterize the respective customer care contact clusters using customer care contact cluster characterization information for the respective customer care contact cluster. In this manner, customer care contact data associated with the sets of customers determined to be associated with the customer care contact clusters based on comparisons of the embeddings of the customer care contact data of the customers with the customer care contact clusters may be used to build up the characterizations of the customer care contact clusters. It is noted that this also may be referred to herein as scoring of customers since the customers are being scored against (or compared) to the customer care contacts clusters in order to categorize the customers based on the embeddings of the customer care contact data of the customers.

The customer management system 150 may be configured to specify the customer care contact cluster characterization information for the customer care contact clusters based on various attributes, parameters, and so forth. The characterizations of the customer care contact clusters may be based on the attributes of the customer care contact information (and, thus, customer care contact data of customers) used to generate the embeddings that were then clustered to form the customer care contact clusters, parameters which may be determined based on the customer care contact information (and, thus, customer care contact data of customers) used to generate the embeddings that were then clustered to form the customer care contact clusters and/or analysis of the customer care contact information (and, thus, customer care contact data of customers) used to generate the embeddings that were then clustered to form the customer care contact clusters, and so forth. It will be appreciated that the characterizations of the customer care contact clusters (and associated customer care contact cluster characterization information) also may be referred to as descriptions of the customer care contact clusters (and associated customer care contact cluster description information).

The characterizations of the customer care contact clusters, as indicated above, may be based on the attributes of the customer care contact information (and, thus, customer care contact data of the customers) used to generate the embeddings that were then clustered to form the customer care contact clusters (e.g., attributes such as an indication of a quantity of the customer care contacts of the customer, an indication of one or more customer care contact channel types used for the customer contacts of the customer, an indication of a customer care contact channel type sequence of the customer care contacts of the customer, an indication of a set of gap times between adjacent ones of the customer care contacts of the customer, an indication of a set of customer care contact reasons of the customer for the customer care contacts of the customer, and so forth). For example, a customer care contact cluster may be characterized as representing customers that have only a single customer care contact that occurred in a store for account change purposes. For example, a customer care contact cluster may be characterized as representing customers that have only a single customer care contact that occurred via a phone call for billing purposes. For example, a customer care contact cluster may be characterized as representing customers that have a medium level of customer care contact (e.g., 4-6 customer care contacts within a 60 day period of time), all or mostly in-store contacts, primarily for purposes of feature change requests. For example, a customer care contact cluster may be characterized as representing customers that have a high level of customer care contact (e.g., 7 or more customer care contacts within a 60 day period of time) primarily for purposes of feature change requests. It will be appreciated that these are merely a few of the various ways in which customer care contact clusters may be characterized.

The characterization of the customer care contact clusters, as indicated above, may be based on other parameters which may be determined based on the customer care contact data used to generate the embeddings that were then clustered to form the customer care contact clusters and/or analysis of the customer care contact data used to generate the embeddings that were then clustered to form the customer care contact clusters (e.g., parameters such as a cluster label parameter, a percentage of contacts parameter, a percentage of customers parameter, a top contact pattern parameter, a top contact reason as a percentage of customer contacts parameter, and so forth). For example, a customer care contact cluster may be characterized as representing customers that have only two customer care contacts that occurred via phone calls for device and services help purposes with an average contact gap of three days. For example, a customer care contact cluster may be characterized as representing customers that have only two customer care contacts that occurred via phone calls for billing purposes with an average contact gap of sixteen days. For example, a customer care contact cluster may be characterized as representing customers that have a high level of customer care contact, mainly or entirely via phone calls, with an indication that although this group of customers represents only 1% of the customer base, these customers account for nearly 10% of the customer care contacts. It will be appreciated that these are merely a few of the various ways in which customer care contact clusters may be characterized.

The customer management system 150, as indicated above, may be configured to select, from the plurality of customers based on the customer care contact cluster characterization information, a set of customers. The set of customers may include each of the customers associated with multiple customer care contact clusters, a subset of the customers associated with multiple customer care contact clusters, each of the customers associated with a single customer care contact cluster, a subset of the customers associated with a single customer care contact cluster, a single customer (e.g., selected from a customer care contact cluster that was selected, selected independent of a customer care contact cluster and then evaluated with respect to the one of the customer care contact clusters with which the customer is associated, or the like), and so forth.

The selection of the set of customers, as indicated above, may be based on selection of a customer care contact cluster and selection of the set of customers based on the selected customer care contact cluster. The customer care contact cluster may be selected in various ways, such as based on customer care contact cluster characterization information (e.g., clusters representing high frequency of customer care contacts using relatively expensive customer care contact channel types, clusters having contact sequences that have particular cross-channel characteristics that indicate expected likely future customer care contacts using relatively expensive customer care contact channel types, and so forth), based on cluster analysis performed on the clusters (e.g., matching clusters represented based on different variables, such as by correlating clusters representing a relatively small number of customers with clusters representing a relatively large number of customer care contacts), and so forth. In one example, the customer care contact cluster may be selected by generating, based on at least one cluster attribute common to the customer care contact clusters, a first cluster plot including the customer care contact clusters (e.g., plotting gap days against average number of customer care contacts) that is based on a first cluster parameter (e.g., number of customers) and a second cluster plot including the customer care contact clusters (e.g., again, plotting gap days against average number of customer care contacts) that is based on a second cluster parameter (e.g., total number of customer care contacts) and selecting, based on the first cluster plot and the second cluster plot, the one of the customer care contact clusters.

In one example, the selection of the set of customers may include selecting, from the set of customer care contact clusters based on the respective customer care contact cluster characterization information for the customer care contact clusters, one of the customer care contact clusters and identifying ones of the customers in the plurality of customers associated with the one of the customer care contact clusters (e.g., where a customer care action may be applied to all of the customers associated with the customer care contact cluster, such as for a cluster of customers that have a high customer care contact frequency using relatively costly contact channels such as store visits and telephone calls).

In one example, the selection of the set of customers may include selecting, from the set of customer care contact clusters based on the respective customer care contact cluster characterization information for the customer care contact clusters, one of the customer care contact clusters and identifying a subset of customers in the plurality of customers associated with the one of the customer care contact clusters that satisfy certain criteria (e.g., where a customer care action may be applied to a subset of the customers associated with the customer care contact cluster, such as for targeting from a cluster of customers that have a high customer care contact frequency those customers that have a quantity of customer care contacts that are above a threshold).

The selection of the set of customers, as indicated above, may be based on selection of a customer for evaluation and then determining, based on evaluation of the customer, whether to select the customer for inclusion in the set of customers. In one example, the selection of the set of customers may include selecting one of the customers in the customer base, identifying, based on the customer care contact data associated with the customer and the respective customer care contact cluster characterization information for the customer care contact clusters, one of the customer care contact clusters with which the one of the customers is associated, and selecting, based on the respective customer care contact cluster characterization information for the one of the customer care contact clusters with which the one of the customers is associated, the one of the customers for inclusion in the set of customers. In one example, the selection of the set of customers may include selecting one of the customers in the customer base and then scoring the customer for determining whether to include the customer in the set of customers for which the customer care action is initiated.

The customer management system 150, as indicated above, may be configured to support customer care for customers by scoring the customers based on customer care contact clusters determined based on analysis of customer care contact data for the customers. The scoring of customers may include, for each of the customers, identifying one of the customer care contact clusters with which the customer care behavior of the customer is most closely associated and assigning a score to the customer based on the identification of the one of the clusters with which the customer care behavior of the customer is most closely associated. The identification of the one of the customer care contact clusters with which the customer care behavior of the customer is most closely associated may be based on comparison of a customer care contact embedding of the customer with the centroids of the customer care contact clusters and/or comparison of customer care contact data of the customer with customer care contact cluster characterization information. The assignment of the score to the customer may be based on the customer care contact cluster characterization information indicative of the characteristics of customer care contact behavior represented by the clusters, since scoring of the customers on this basis enables identification of customers for which the customer care contact behavior matches customer care contact behavior that the network provider would like to control or influence.

For example, if a cluster represents customers that tend to rely on the store visit and telephone call customer care contact channel types for customer care contacts, identification of customers that match this cluster may enable the network provider to initiate customer care contact with those customers in order to try to cause or influence those customers to rely on the chat-based customer care contact channel type for future customer care contacts by those customers (e.g., the scores assigned to these customers will enable the network provider to identify these customers from among the full set of customers in order to initiate specific types of targeted customer care contacts).

For example, if a cluster represents customers that tend to rely on the chat-based customer care contact channel type for customer care contacts, identification of customers that match this cluster may enable the network provider to give those customers a lower priority in order to focus on controlling customer care contacts for other customers that tend to use more costly customer care contact channel types (e.g., the scores assigned to these customers will enable the network provider to identify these customers from among the full set of customers in order to focus on initiating specific types of targeted customer care contacts for other customers that do not fall within this group).

For example, if a cluster represents customers that utilize customer care contact channel types most frequently, identification of customers that match this cluster may enable the network provider to initiate customer care contact with those customers in order to try to cause or influence those customers to rely on less-costly customer care contact channel types for the expected large number of future customer care contacts by those customers (e.g., the scores assigned to these customers will enable the network provider to identify these customers from among the full set of customers in order to initiate specific types of targeted customer care contacts). For example, the network provider may initiate customer care contact with those customers in order to try to cause or influence those customers to rely on the chat-based customer care contact channel type or to rely on the automated customer care contact channel type (e.g., directing customers to websites, informational or instructional videos, automated tools, and so forth) so as not to burden customer care agents.

For example, if a cluster represents customers that tend to follow each phone call with a store visit, identification of customers that match this cluster may enable the network provider to initiate customer care contact with those customers in order to try to cause or influence those customers to rely on less-costly customer care contact channel types for the expected large number of future customer care contacts by those customers (e.g., the scores assigned to these customers will enable the network provider to identify these customers from among the full set of customers in order to initiate specific types of targeted customer care contacts). For example, the network provider may initiate customer care contact with those customers in order to try to cause or influence those customers to rely on the chat-based customer care contact channel type after each phone call in order to reduce or eliminate store visits for customer care reasons or to rely on the automated customer care contact channel type (e.g., sending emails, texts, or other messages to direct customers to websites, informational or instructional videos, tools, and so forth) so as not to burden customer care agents.

The assignment of the score to the customer may be based on the one of the clusters with which the customer care behavior of the customer is determined to be most closely associated. For example, different clusters may have different scores or score ranges associated therewith depending on the characteristics of customer care contact behavior represented by the clusters (e.g., such as where customer care contact behavior that includes many store visits and/or calls may have a first score or scoring range associated therewith whereas customer care contact behavior that includes mostly chat-based contacts may have a second score or scoring range associated therewith).

The assignment of the score to the customer may be based on a measure of how closely the customer care contact behavior of the customer matches the one of the clusters with which the customer care contact behavior of the customer is determined to be most closely associated. For example, closely matching a cluster that represents a high frequency of store visits may result in a different score than only loosely matching a cluster that represents a high frequency of store visits.

It will be appreciated that, although primarily presented with respect to examples in which scoring of a customer is based on identification of a single cluster with which the customer care behavior of the customer is determined to be associated, in at least some examples the scoring of a customer may be based on identification of multiple clusters with which the customer care behavior of the customer is determined to be associated (in which case the scoring may be based on the multiple clusters with which the customer care behavior of the customer is determined to be associated, such as by determining a score for the customer based on a determination that the customer care behavior of the customer is determined to be associated with that particular combination of clusters, determining a score for a customer based on weighting of the clusters based on characteristics of the clusters and/or measures of closeness with which the customer care behavior of the customer matches the clusters, and so forth).

The customer management system 150, as indicated above, may be configured to initiate a customer care action for the set of customers. The customer care action initiated for the set of customers may include one of providing informational content (e.g., information about a product or service, account information, or the like), providing instructional content (e.g., written, aural, and/or visual instructional content for explaining how to use a website for taking care of customer care issues, diagnosing a problem, or the like), providing a link to a resource (e.g., a link to a webpage that may be used by the customer(s) for taking care of customer care needs instead of relying on the in-store or telephone call customer care channels), providing access to a tool (e.g., a tool which may be used by the customer(s) for taking care of customer care needs instead of relying on the in-store or telephone call customer care channels, such as a tool for accessing account information, a tool for diagnosing and resolving a service problem, or the like), and so forth. The customer care action for the set of customers may be initiated by sending emails to the customers, sending text messages to the customers, sending short message service (SMS) messages to the customers, sending content items to the customers, and so forth. The customer care action may be initiated for various purposes or for achieving various goals, such as for controlling or influencing customers to initiate less customer care contacts, to use less costly customer care contact channel types, to operate independently without using customer care channels, and so forth.

It will be appreciated that the customer management system 150 may be configured to perform various other functions for providing customer care for customers of communication networks such as the network 105, as discussed further herein.

It will be appreciated that, although presented as a single system for purposes of clarity, the various functions described as being performed by the customer management system 150 may be distributed across multiple systems which may cooperate to provide such functions.

It should be noted that the system 100 has been simplified. In other words, the system 100 may be implemented in a different form than that illustrated in FIG. 1. For example, the system 100 may be expanded to include additional networks (e.g., a content distribution network (CDN), a network operations center (NOC) network, and the like), additional network devices (e.g., border devices, routers, switches, policy servers, security devices, gateways, and the like), and so forth, without altering the scope of the present disclosure. In addition, system 100 may be altered to omit various elements, substitute elements for devices that perform the same or similar functions and/or combine elements that are illustrated as separate devices. For example, SDN controller 155, customer management system 150, and/or other network devices may include functions that are spread across several devices that operate collectively as a SDN controller, a customer management system, an edge device, and so forth. Thus, these and other modifications of the system 100 are all contemplated within the scope of the present disclosure.

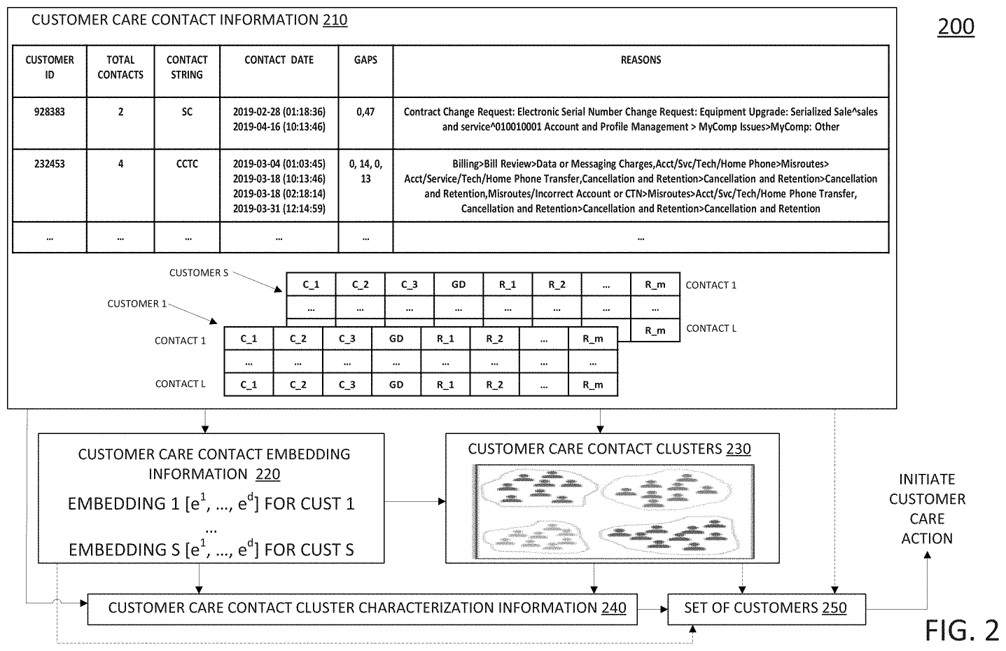

FIG. 2 illustrates an example process for initiating customer care for customers based on customer care contact behavior of customers, according to the present disclosure. The process 200 primarily illustrates the manner in which the customer care contact information for a customer base is analyzed to initiate a customer care action for a set of customers of the customer base. The process 200 of FIG. 2 may be executed by a management system (e.g., customer management system 150 of FIG. 1). The process 200 utilizes various types of information, including customer care contact information 210, customer care contact embedding information 220, customer care contact clusters 230, customer care contact cluster characterization information 240, and a set of customers 250 for which a customer care action may be initiated.

In the process 200, the customer care contact information 210 is obtained. The customer care contact information 210 may include raw customer care contact information for customers (e.g., an example is provided at the top of the customer care contact information 210) and/or processed customer care contact information for customers (e.g., an example is provided at the bottom of the customer care contact information 210). The raw customer care contact information and the processed customer care contact information provide, for each of the customers, customer care contact data associated with a set, or sequence, of one or more customer care contacts by the customer with customer care agents.

The raw customer care contact information may include, for each customer, customer care contact data that includes a total number of customer care contacts, a customer care contact string indicative of the customer care contact channel types used in the sequence of customer care contacts, gap time information for gaps between customer care contacts in the sequence of customer care contacts, reason information including reasons for each of the customer care contacts in the sequence of customer care contacts, and so forth. It will be appreciated that the raw customer care contact information of the customers may be organized in various formats, may include various other types of information, and so forth.

The processed customer care contact information is configured to represent the raw customer care contact information for the customers using data structures which may be organized as sequences of data structures for the customers where the sequences of data structures for the customers correspond to the sequences of customer care contacts of the customers. For example, for a given customer, each data structure represents one of the customer care contacts in the sequence of customer care contacts of the customer. For example, for a given customer care contact of a given customer, a data structure such as [c¹, c², c³, gd, r¹, r², . . . , r^{m}] may be used to represent the raw customer care contact data of the customer care contact of the customer, and multiple such data structures may be used to represent the raw customer care contact data of multiple customer care contacts in a sequence of customer care contacts of the customer. For example, in process 200, customer 1 is illustrated as having L data structures representing L customer care contacts by that customer, where each of the L data structures includes customer care contact data such as the customer care contact channel type for the customer contact of the customer, a number of gap days since a previous customer care contact of the customer, and indications of one or more reasons for the customer contact of the customer. In other words, each customer may be represented as a sequence of customer care contacts where each customer care contact is represented with high dimensions of attributes such as contact channel, gap days, and reasons where each reason is represented by a high dimension of variables and where each variable corresponds to an existing reason value.

It will be appreciated that both the raw customer care contact data and the processed customer care contact data for a customer may be considered to be customer care contact data indicative of a customer care contact sequence that represents the customer care contact behavior of the customer.

In the process 200, the customer care contact embedding information 220 is determined based on the customer care contact information 210. The customer care contact embedding information 220 may be determined based on the raw customer care contact information of the customer care contact information 210 and/or based on the processed customer care contact information of the customer care contact information 210. The customer care contact embedding information 220, when determined based on the processed customer care contact information of the customer care contact information 210, may be determined using a sequence-to-sequence (Seq2Seq) generative learning model (e.g., an RNN-based model). The customer care contact embedding information 220 includes the customer care contact embeddings determined for the customers based on the customer care contact data of the customers, respectively.

In the process 200, the customer care contact clusters 230 are formed by clustering the customer care contact embedding information 220. The customer care contact clusters 230 are formed by clustering the customer care contact embeddings of the customer care contact embedding information 220 into groups of customer care contact embeddings. The customer care contact clusters 230 may be formed using a clustering model (e.g., a centroid-based clustering model, such as k-means, or other suitable clustering models). The customer care contact clusters 230 may be formed using a clustering model configured to cluster a set of S customer care contact embeddings into K groups. It will be appreciated that, since the customer care contact embedding information 220 includes the customer care contact embeddings of the customers that represent the customer care contact sequences of the customers, the clustering of the customer care contact embedding information 220 also may be considered to be a clustering of S customer care contact sequences for the customers into K groups of customer care contact embeddings based on the similarity of the customer care contact sequences for the customers.

In the process 200, the customer care contact cluster characterization information 240 is determined for the customer care contact clusters 230. The customer care contact cluster characterization information 240 for the customer care contact clusters 230 is configured to provide descriptions of the customer care contact clusters 230, respectively, for use in identifying one or more customers for which customer care actions may be initiated. The customer care contact cluster characterization information 240 for the customer care contact clusters 230 may be determined based on the customer care contact information 210 and the customer care contact embedding information 220.

In the process 200, the set of customers 250 is determined based on the customer care contact cluster characterization information 240. The set of customers 250 may include one or more customers for which a customer care action may be initiated. The set of customers 250 may be determined in various ways based on one or more of the customer care contact information 210, the customer care contact embedding information 220, and the customer care contact clusters 230.

In the process 200, a customer care action may be initiated for the set of customers 250. The customer care action may be initiated for the set of customers 250 for various purposes, such as to improve customer care for the customers, reduce the cost of providing customer care for the customers, and so forth. The customer care action may be initiated to attempt to direct certain customers (e.g., customers known to be high contact customers, customers predicted to be high contact customers, and so forth) to less costly customer care contact channel types such as the chat-based customer care contact channel or the automated customer care contact channel that does not rely on customer care agent interactions for customer care for the customers (e.g., directing the customers to informational content, instructional content, websites, tools, etc., which do not require the customer to interact with a customer care agent).

It will be appreciated that, although process 200 is primarily presented with respect to specific relationships between the various types of information, various other relationships between the various types of information may be supported within the context of the process 200 of FIG. 2.

It will be appreciated that various aspects of customer care presented with respect to the system 100 of FIG. 1 may be incorporated within the process 200 of FIG. 2 and, similarly, that various aspects of customer care presented with respect to the process 200 of FIG. 2 may be incorporated within the system 100 of FIG. 1.

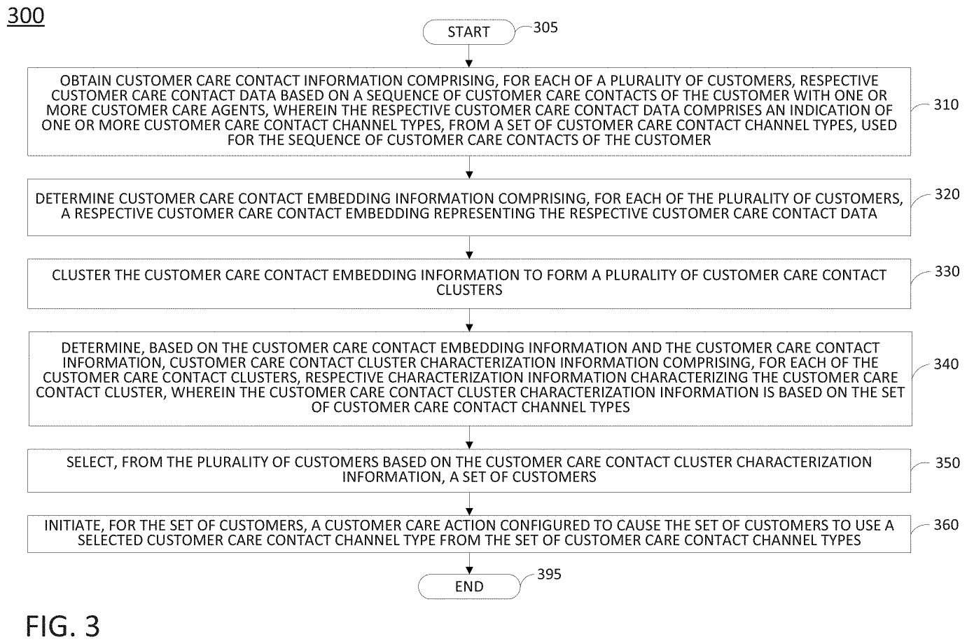

FIG. 3 illustrates an example method for initiating a customer care action for customers based on customer care contact behavior of customers. In one example, the steps, operations, or functions of the method 300 may be performed by any one or more of the components of the system 100 depicted in FIG. 1. For example, in one embodiment, the method 300 may be performed by a management system (e.g., customer management system 150). In one example, the steps, functions, or operations of method 300 may be performed by a computing device or processing system, such as computing system 400 and/or a hardware processor element 402 as described in connection with FIG. 4 below. For instance, the computing system 400 may represent at least a portion of a management system in accordance with the present disclosure. In one example, the steps, functions, or operations of method 300 may be performed by a processing system comprising a plurality of such computing devices as represented by the computing system 400. For illustrative purposes, the method 300 is described in greater detail below in connection with an example performed by a processing system. The method 300 begins in step 305 and proceeds to step 310.

At step 310, the processing system may obtain customer care contact information comprising, for each of a plurality of customers, respective customer care contact data based on a sequence of customer care contacts of the customer with one or more customer care agents, wherein the respective customer care contact data comprises an indication of one or more customer care contact channel types, from a set of customer care contact channel types, used for the sequence of customer care contacts of the customer. In one example, the respective customer care contact data further includes at least one of, an indication of a quantity of customer care contacts in the sequence of customer care contacts of the customer, an indication of a customer care contact channel type sequence in the sequence of customer care contacts of the customer, an indication of a set of gap times between adjacent customer care contacts in the sequence of customer care contacts of the customer, or an indication of a set of customer care contact reasons for customer care contacts in the sequence of customer care contacts of the customer. In one example, the set of customer care contact channel types includes a store visit customer care contact channel type, a telephone call customer care contact channel type, a chat-based customer care contact channel type, or an automated customer care contact channel type.

At step 320, the processing system may determine customer care contact embedding information comprising, for each of the plurality of customers, a respective customer care contact embedding representing the respective customer care contact data. In one example, for at least one of the customers, the respective customer care contact embedding is determined based on conversion of a first data sequence including the respective customer care contact data and having a first dimensionality to a second data sequence including the respective customer care contact embedding and having a second dimensionality lower than the first dimensionality. In one example, the customer care contact embedding information is determined based on a sequence-to-sequence generative learning model. In one example, the sequence-to-sequence generative learning model comprises a recurrent neural network based model.

At step 330, the processing system may cluster the customer care contact embedding information to form a plurality of customer care contact clusters. In one example, the customer care contact embedding information is clustered to form the plurality of customer care contact clusters based on a centroid-based clustering model. In one example, the centroid-based clustering model comprises a k-means clustering model.

At step 340, the processing system may determine, based on the customer care contact embedding information and the customer care contact information, customer care contact cluster characterization information comprising, for each of the customer care contact clusters, respective characterization information characterizing the customer care contact cluster, wherein the customer care contact cluster characterization information is based on the set of customer care contact channel types. In one example, the customer care contact cluster characterization information is based on a set of customer care contact data attributes of the customer care contact information In one example, the set of customer care contact data attributes comprises at least one of: a quantity of customer care contacts attribute, a customer care contact channel type sequence attribute, a customer care contact gap time attribute, or a customer care contact reason attribute. In one example, the customer care contact cluster characterization information includes, for at least one of the customer care contact clusters, at least one of: a cluster label parameter, a percentage of contacts parameter, a percentage of customers parameter, a top contact pattern parameter, or a top contact reason as a percentage of customer contacts parameter. In one example, determining the customer care contact cluster characterization information includes determining, by the processing system for each of the customer care contact clusters based on the customer care contact embedding information, a respective group of the customers including ones of the customers associated with the respective customer care contact cluster and determining, by the processing system for each of the customer care contact clusters based on the respective customer care contact data of the ones of the customers included in the respective group of the customers associated with the respective customer care contact cluster, the respective characterization information configured to characterize the respective customer care contact cluster.

At step 350, the processing system may select, from the plurality of customers based on the customer care contact cluster characterization information, a set of customers. In one example, selecting the set of customers includes selecting, by the processing system from the plurality of customer care contact clusters based on the customer care contact cluster characterization information, one of the customer care contact clusters and identifying, by the processing system, ones of the customers in the plurality of customers that are associated with the one of the customer care contact clusters. In one example, selecting the one of the customer care contact clusters includes generating, by the processing system based on at least one cluster attribute common to the plurality of customer care contact clusters, a first cluster plot that includes the plurality of customer care contact clusters and that is based on a first cluster parameter and a second cluster plot that includes the plurality of customer care contact clusters and that is based on a second cluster parameter and selecting, by the processing system based on the first cluster plot and the second cluster plot, the one of the customer care contact clusters. In one example, selecting the set of customers includes selecting, by the processing system, one of the customers in the plurality of customers, identifying, by the processing system based on the respective customer care contact data for the one of the customers and the customer care contact cluster characterization information, one of the plurality of customer care contact clusters with which the one of the customers is associated, and selecting, by the processing system based on the respective characterization information characterizing the one of the plurality of customer care contact clusters with which the one of the customers is associated, the one of the customers.

At step 360, the processing system may initiate, for the set of customers, a customer care action configured to cause the set of customers to use a selected customer care contact channel type from the set of customer care contact channel types. In one example, initiating the customer care action for the set of customers comprises at least one of sending an e-mail, sending a text message, sending a short message service message, or sending a content item. In one example, the selected one of the customer care contact channel types may be selected for at least one of reducing a cost of providing customer care to the set of customers, improving customer service provided to the set of customers, controlling a distribution of customer care contacts across customer care contact channel types, and so forth. In one example, the selected one of the customer care contact channel types comprises a chat-based customer care contact channel type or an automated customer care contact channel type.

Following step 360, the method 300 proceeds to step 395 where the method 300 ends.

It will be appreciated that, although presented as ending (for purposes of clarity), the method 300 may continue to execute for identifying one or more additional sets of customers and initiating one or more additional customer care actions for the one or more additional sets of customers. For example, the method 300 may further include selecting, by the processing system from the plurality of customers based on the customer care contact cluster characterization information, a second set of customers and initiating, by the processing system for the second set of customers, a second customer care action, wherein the second customer care action is based on at least one of providing informational content, providing instructional content, providing a link to a resource, or providing access to a tool. It will be appreciated that various other steps of method 300 may be re-executed to continue to provide improved customer care for customers.

In addition, although not specifically specified, one or more steps, functions, or operations of the method 300 may include a storing, displaying and/or outputting step as required for a particular application. In other words, any data, records, fields, and/or intermediate results discussed in the method 300 can be stored, displayed, and/or outputted either on the device executing the respective method or to another device, as required for a particular application.

Furthermore, steps, blocks, functions, or operations in FIG. 3 that recite a determining operation or involve a decision do not necessarily require that both branches of the determining operation be practiced. In other words, one of the branches of the determining operation can be deemed as an optional step. Moreover, steps, blocks, functions, or operations of the above-described method 300 can be combined, separated, omitted, and/or performed in a different order from that described above, without departing from the examples of the present disclosure.

Various examples presented herein may be configured to provide improved customer care by overcoming various complexities associated with analysis of customer care information. Large network providers can spend billions of dollars annually on customer care across multiple contact channels. For example, for some large network providers with millions of customers, there can be millions or even tens of millions of customer-initiated agent-based care contacts monthly across the customer care channels of store visits, calls, and chats. It has been determined that, while each customer care contact is important and includes rich information (e.g., customer identity, customer care contact channel type used, contact timestamp information, customer care contact reasons, and so forth), studying sequences of customer care contacts by customers may, in at least some ways, provide a better context for understating the customer care behavior of the customers. However, analyzing customer care contact sequences of customers may become a difficult task when dealing with millions of customers, because it may be challenging to cluster contact sequences (e.g., due to their multi-attribute nature, variant-lengths, and high-dimensional reason-code feature), it is possible that the clustering algorithms (e.g., K-means clustering) may suffer from the “curse of dimensionality,” and it may be demanding to process data at such a large scale.

Various examples presented herein may be configured to overcome various complexities associated with analysis of customer care information. In one example, such complexities may be overcome or mitigated by applying a scoring scheme to the customer care contact behavior of each individual customer and using the scoring to support various additional processes. In one example, a deep-learning method may be used to learn and characterize customer behavior based on their past contact sequences to provide learned clusters, the learned clusters may be applied to score the customer base, and the results of the scoring may be used to support one or more additional processes (e.g., a proactive customer care process and so forth). In one example, a Seq2Seq generative learning model or method may be used to learn the embeddings of contact sequences (e.g., an RNN-based method may be used to learn the embeddings of customer care journey sequences, which also may be referred to as customer care journey embeddings or, more simply, journey embeddings) and the learned Seq2Seq embeddings may then be clustered (e.g., using a K-means clustering method or other suitable clustering method). It is noted that one advantage of Seq2Seq embeddings is that it becomes possible to learn the latent transitions between customer care contacts of customers. This classification is then used as an additional input to various other models and processes (e.g., predictive customer care models, proactive customer care processes, personalized service processes, and so forth).

Various examples presented herein may be configured to use analysis of customer care information to support improve various aspects of customer care. In one example, the results of scoring may be used in combination with customer information (e.g., customer profile attributes, customer events, and so forth) in order to proactively offer digital information or solutions to certain customers (e.g., customers who are predicted to use relatively high cost customer care contact channel types such as store visits and phone calls), thereby reducing overall customer care costs. In one example, the digital information or solutions may be sent to customers via email, SMS, personalized content on the web, and so forth. In this manner, meaningful clustering and classification of customer care contact journeys can provide insight into individual customer behavior, provide an understand of the entire customer base, provide input to targeted strategies for proactive customer care or personalized service, and so forth.

Various examples presented herein may be configured to provide improved customer care by improving various aspects of supporting customer care for customers. In one example, a care contact behavior model with associated embedding, clustering, and scoring based on deep learning may be provided (e.g., it has been determined, based on various experiments, that use of embeddings for customer care sequence analysis outperforms principal component analysis without embeddings and, further that the clustering results exhibit highly meaningful clusters). In one example, use of customer care contact behavior may improve performance of customer care predictive models. In one example, customer care contact sequences may be analyzed to learn the semantics of customer care interactions. In one example, learned semantics of customer care interactions may improve the identification of key patterns of customer behavior. In one example, patterns of customer behavior may be used as simple features to improve various proactive customer care processes. In one example, learning and classification based on customer care contact sequences (e.g., to learn and generate meaningful clusters of contact behavior) may be used for segment-based proactive customer care, which also may include creation of micro-services for segment-based proactive customer care. In one example, learning and classification based on customer care contact sequences may provide improved care volume prediction, which may be used for customer care workforce management, for enhancing a predictive model for network care, and so forth.

It will be appreciated that, although primarily described with respect to supporting customer care within a particular context (namely, customer care for customers of a telecommunications network provider having specific customer care channels), various example presented herein may be configured or adapted to support customer care within various other contexts (e.g., for other types of entities providing customer care, for entities providing customer care using other types of customer care channels, or the like, as well as various combinations thereof).

FIG. 4 depicts a high-level block diagram of a computing system 400 (e.g., a computing device, or processing system) specifically programmed to perform the functions described herein. For example, any one or more components or devices illustrated in FIG. 1, described in conjunction with the process 200 of FIG. 2, or described in connection with the method 300 of FIG. 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where hardware processor element may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for supporting customer care for customers, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that, although only one hardware processor element 402 is shown, the computing device may employ a plurality of hardware processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for supporting customer care for customers (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for supporting customer care for customers (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, customer care contact information comprising, for each of a plurality of customers, respective customer care contact data based on a sequence of customer care contacts of the customer with one or more customer care agents, wherein the respective customer care contact data comprises an indication of one or more customer care contact channel types, from a set of customer care contact channel types, used for the sequence of customer care contacts of the customer;
determining, by the processing system, customer care contact embedding information comprising, for each of the plurality of customers, a respective customer care contact embedding representing the respective customer care contact data;
clustering, by the processing system, the customer care contact embedding information to form a plurality of customer care contact clusters;
determining, by the processing system based on the customer care contact embedding information and the customer care contact information, customer care contact cluster characterization information comprising, for each of the customer care contact clusters, respective characterization information characterizing the customer care contact cluster, wherein the customer care contact cluster characterization information is based on the set of customer care contact channel types;
selecting, by the processing system from the plurality of customers based on the customer care contact cluster characterization information, a set of customers; and
initiating, by the processing system for the set of customers, a customer care action configured to cause the set of customers to use a selected customer care contact channel type from the set of customer care contact channel types.

2. The method of claim 1, wherein the respective customer care contact data further comprises at least one of:
an indication of a quantity of customer care contacts in the sequence of customer care contacts of the customer;
an indication of a customer care contact channel type sequence in the sequence of customer care contacts of the customer;
an indication of a set of gap times between adjacent customer care contacts in the sequence of customer care contacts of the customer; or
an indication of a set of customer care contact reasons for customer care contacts in the sequence of customer care contacts of the customer.

3. The method of claim 1, wherein the set of customer care contact channel types includes a store visit customer care contact channel type, a telephone call customer care contact channel type, a chat-based customer care contact channel type, and an automated customer care contact channel type.

4. The method of claim 1, wherein, for at least one of the customers, the respective customer care contact embedding is determined based on conversion of a first data sequence including the respective customer care contact data and having a first dimensionality to a second data sequence including the respective customer care contact embedding and having a second dimensionality lower than the first dimensionality.

5. The method of claim 1, wherein the customer care contact embedding information is determined based on a sequence-to-sequence generative learning model.

6. The method of claim 5, wherein the sequence-to-sequence generative learning model comprises a recurrent neural network based model.

7. The method of claim 1, wherein the customer care contact embedding information is clustered to form the plurality of customer care contact clusters based on a centroid-based clustering model.

8. The method of claim 7, wherein the centroid-based clustering model comprises a k-means clustering model.

9. The method of claim 1, wherein the customer care contact cluster characterization information is based on a set of customer care contact data attributes of the customer care contact information.

10. The method of claim 9, wherein the set of customer care contact data attributes comprises at least one of: a quantity of customer care contacts attribute, a customer care contact channel type sequence attribute, a customer care contact gap time attribute, or a customer care contact reason attribute.

11. The method of claim 1, wherein the customer care contact cluster characterization information includes, for at least one of the customer care contact clusters, at least one of: a cluster label parameter, a percentage of contacts parameter, a percentage of customers parameter, a top contact pattern parameter, or a top contact reason as a percentage of customer contacts parameter.

12. The method of claim 1, wherein determining the customer care contact cluster characterization information comprises:
determining, by the processing system for each of the customer care contact clusters based on the customer care contact embedding information, a respective group of the customers including ones of the customers associated with the respective customer care contact cluster; and
determining, by the processing system for each of the customer care contact clusters based on the respective customer care contact data of the ones of the customers included in the respective group of the customers associated with the respective customer care contact cluster, the respective characterization information configured to characterize the respective customer care contact cluster.

13. The method of claim 1, wherein selecting the set of customers comprises:
selecting, by the processing system from the plurality of customer care contact clusters based on the customer care contact cluster characterization information, one of the customer care contact clusters; and
identifying, by the processing system, ones of the customers in the plurality of customers that are associated with the one of the customer care contact clusters.

14. The method of claim 13, wherein selecting the one of the customer care contact clusters comprises:
generating, by the processing system based on at least one cluster attribute common to the plurality of customer care contact clusters, a first cluster plot that includes the plurality of customer care contact clusters and that is based on a first cluster parameter and a second cluster plot that includes the plurality of customer care contact clusters and that is based on a second cluster parameter; and
selecting, by the processing system based on the first cluster plot and the second cluster plot, the one of the customer care contact clusters.

15. The method of claim 1, wherein selecting the set of customers comprises:
selecting, by the processing system, one of the customers in the plurality of customers;
identifying, by the processing system based on the respective customer care contact data for the one of the customers and the customer care contact cluster characterization information, one of the plurality of customer care contact clusters with which the one of the customers is associated; and
selecting, by the processing system based on the respective characterization information characterizing the one of the plurality of customer care contact clusters with which the one of the customers is associated, the one of the customers.

16. The method of claim 1, wherein initiating the customer care action for the set of customers comprises at least one of: sending an e-mail, sending a text message, sending a short message service message, or sending a content item.

17. The method of claim 1, wherein the selected one of the customer care contact channel types comprises a chat-based customer care contact channel type or an automated customer care contact channel type.

18. The method of claim 1, further comprising:
selecting, by the processing system from the plurality of customers based on the customer care contact cluster characterization information, a second set of customers; and
initiating, by the processing system for the second set of customers, a second customer care action, wherein the second customer care action is based on at least one of providing informational content, providing instructional content, providing a link to a resource, or providing access to a tool.

19. A non-transitory computer-readable medium storing instructions which, when executed by a processing system including at least one processor, cause the processing system to perform operations, the operations comprising:
obtaining customer care contact information comprising, for each of a plurality of customers, respective customer care contact data based on a sequence of customer care contacts of the customer with one or more customer care agents, wherein the respective customer care contact data comprises an indication of one or more customer care contact channel types, from a set of customer care contact channel types, used for the sequence of customer care contacts of the customer;
determining customer care contact embedding information comprising, for each of the plurality of customers, a respective customer care contact embedding representing the respective customer care contact data;
clustering the customer care contact embedding information to form a plurality of customer care contact clusters;
determining, based on the customer care contact embedding information and the customer care contact information, customer care contact cluster characterization information comprising, for each of the customer care contact clusters, respective characterization information characterizing the customer care contact cluster, wherein the customer care contact cluster characterization information is based on the set of customer care contact channel types;
selecting, from the plurality of customers based on the customer care contact cluster characterization information, a set of customers; and
initiating, for the set of customers, a customer care action configured to cause the set of customers to use a selected customer care contact channel type from the set of customer care contact channel types.

20. An apparatus comprising:
a processing system including at least one processor; and
a computer-readable medium storing instructions which, when executed by the processing system, cause the processing system to perform operations, the operations comprising:
obtaining customer care contact information comprising, for each of a plurality of customers, respective customer care contact data based on a sequence of customer care contacts of the customer with one or more customer care agents, wherein the respective customer care contact data comprises an indication of one or more customer care contact channel types, from a set of customer care contact channel types, used for the sequence of customer care contacts of the customer;
determining customer care contact embedding information comprising, for each of the plurality of customers, a respective customer care contact embedding representing the respective customer care contact data;
clustering the customer care contact embedding information to form a plurality of customer care contact clusters;
determining, based on the customer care contact embedding information and the customer care contact information, customer care contact cluster characterization information comprising, for each of the customer care contact clusters, respective characterization information characterizing the customer care contact cluster, wherein the customer care contact cluster characterization information is based on the set of customer care contact channel types;
selecting, from the plurality of customers based on the customer care contact cluster characterization information, a set of customers; and
initiating, for the set of customers, a customer care action configured to cause the set of customers to use a selected customer care contact channel type from the set of customer care contact channel types.
